(19) United States
(12) Patent Application Publication
(10) Pub. No.: US 2007/0052535 A1
(43) Pub. Date: Mar. 8, 2007

(54) Object locator system

(76) Inventor: Tirumala R. Ranganath, Palo Alto, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/219,257

(22) Filed: Sep. 2, 2005

(51) Int. Cl. H04Q 7/00

(52) U.S. Cl. 340/539.32

(57) ABSTRACT

An object locator system in accordance with the invention includes an activator unit and an object incorporating an embedded signal generator to generate a signal that provides location information of the object. A power switch of the object is settable to a first position where a power source of the object is coupled to an electronic load, and to a second position where the power source is coupled to the embedded signal generator.

### DESCRIPTION OF THE RELATED ART

It is a fairly common occurrence to misplace an electronic gadget such as a cordless phone, a cellular phone, or a personal digital assistant (PDA). Several alternative methods are available to locate such a misplaced object.

For example, a misplaced cordless phone may be located by activating a “handset locator” button in the base station unit thereby causing the cordless phone to generate an audible beep that can be used to locate the cordless phone. Unfortunately, this locator method is ineffective when the battery inside the cordless phone has been discharged to a level where the electronic circuitry contained in the cordless phone is no longer functional.

As a further example, a misplaced cellular phone can be located by using another phone to place a call to the cellular phone. The ensuing ringing signal can then be used to locate the cellular phone. Unfortunately, this locator method proves ineffective when the cellular phone has been switched off.

As yet another example, a misplaced object may be located by utilizing a locator system having a signaling device that is attached to an external surface of the object. One such commercially-available locator system offered by Sharper Image TM, uses a hand-held wireless unit containing a number of buttons together with a corresponding number of electronic discs. The electronic discs are attached to several objects that are likely to be misplaced. When any one of the several objects is misplaced, a button on the hand-held wireless unit is depressed. This button corresponds to the electronic disc attached to the misplaced object. Upon button depression, the electronic disc emits an audible signal together with a flashing light, to enable location of the misplaced object. This method of locating an object suffers from several handicaps. For instance, the electronic disc may be dislodged from the object during normal usage of the object. Furthermore, from an aesthetic point of view, an object such as a cellular phone or a PDA loses some visual appeal when an unsightly electronic disc is attached to it.

Based on the above-mentioned handicaps of existing object locator systems, an unaddressed need exists in the industry to overcome such deficiencies and inadequacies.

### SUMMARY

An object locator system in accordance with the invention includes an activator unit and an object incorporating an embedded signal generator to generate a signal that provides location information of the object. A power switch of the object is settable to a first position where a power source of the object is coupled to an electronic load, and to a second position where the power source is coupled to the embedded signal generator.

Clearly, some alternative embodiments may exhibit advantages and features in addition to, or in lieu of, those mentioned above. It is intended that all such alternative embodiments be included within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale. Instead, emphasis is placed upon clearly illustrating the principles of the invention. Moreover, in the drawings, like reference numerals designate corresponding parts throughout the several views.

FIG. 1 shows an exemplary object locator system in accordance with the invention.

FIG. 2 shows a first exemplary embodiment of object locator circuitry contained in an object.

FIG. 3 shows a second exemplary embodiment of object locator circuitry contained in an object.

FIG. 4 shows a third exemplary embodiment of object locator circuitry contained in an object.

FIG. 5 shows a first exemplary embodiment of object locator circuitry contained in an activator unit.

FIG. 6 shows a first exemplary object that houses object locator circuitry in accordance with the invention.

FIG. 7 shows a second exemplary object that houses object locator circuitry in accordance with the invention.

FIG. 8 shows a first exemplary embodiment of an activator unit that houses object locator circuitry in accordance with the invention.

FIG. 9 shows an exemplary object locator network in accordance with the invention.

FIG. 10 is a flowchart of an exemplary method of locating an object.

### DETAILED DESCRIPTION

The various embodiments in accordance with the invention generally describe systems, methods, and networks related to an object locator system. The object locator system includes an activator unit and an object containing an embedded signal generator. In a first exemplary embodiment, power is provided to the embedded signal generator when a power switch of the object is set to an “off” position. In a second exemplary embodiment, the object further includes a power monitor that is used to monitor the provided power when the power switch is in the “off” position. If the provided power drops below a certain threshold, the power monitor disconnects power to all components except the embedded signal generator. These and other exemplary embodiments are described below in further detail.

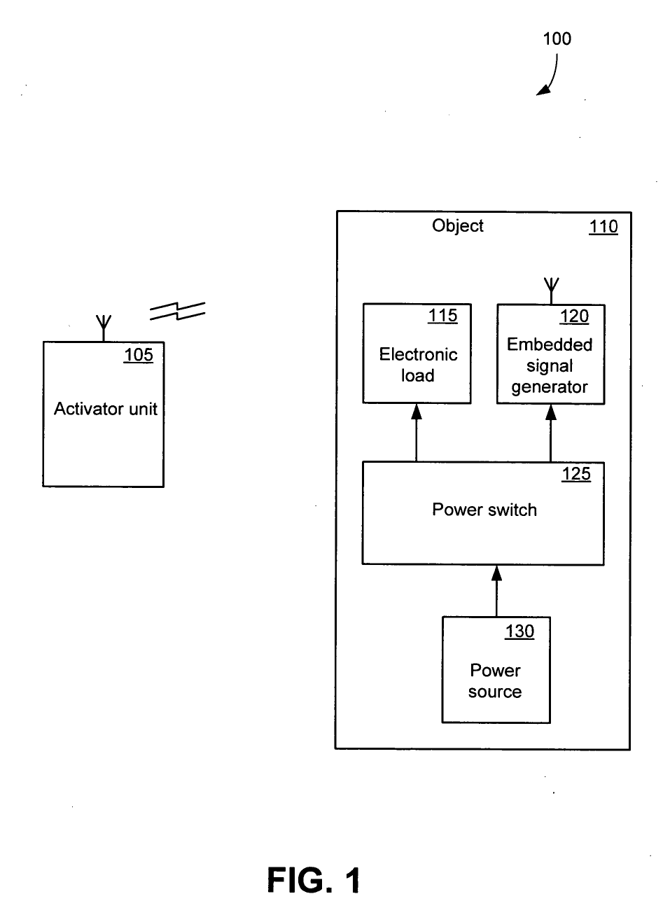

FIG. 1 shows an exemplary object locator system 100 in accordance with the invention. Object locator system 100 includes an activator unit 105 containing a radio-frequency (RF) transmitter and an object 110 incorporating a power source 130, a power switch 125, an electronic load 115, and an embedded signal generator 120. Embedded signal generator 120 includes an RF receiver (not shown) configured to receive an RF signal from the RF transmitter of the activator unit 105. Upon receiving the RF signal, embedded signal generator 120 generates a signal that provides location information of object 110.

Electronic load 115 represents components of object 110 that are powered from power source 130. These components are generally operative to implementing various functions of object 110. For example, when object 110 is a digital camera, electronic load 115 represents components used for various functions associated with capturing and processing an image. Such components include for example, a printed circuit board (PCB) containing integrated circuits and other electronic components, a flash unit, a lens-control motor, and an image-display screen.

Power source 130 is used to provide power to various components contained in object 110. In one exemplary embodiment, power source 130 is a battery. In other exemplary embodiments, power source 130 is a battery bank, an AC-to-AC power supply, an AC-to-DC power supply, or a DC-to-DC power supply. Power source 130 is electrically coupled to power switch 125, which in turn is electrically coupled to electronic load 115 and embedded signal generator 120.

Power switch 125 is an “on-off” switch of object 110. For example, when object 110 is a cellular phone, power switch 125 is a switch that is used to turn on or turn off the cellular phone. Power switch 125 may be implemented using various devices such as a toggle switch, a rocker switch, a membrane switch, a slide switch, and a soft-switch that is displayed upon a display screen. Power switch 125 may be further implemented as a multi-position switch, which includes, for example, a “standby” position.

When power switch 125 is set to an “on” position, power from power source 130 is coupled to electronic load 115, thereby placing object 110 in a primary mode of operation. For example, when object 110 is a cellular phone and power switch 125 is set to an “on” position, the cellular phone is operative to carry out normal phone operations such as receiving calls and sending calls.

When power switch 125 is set to the “off” position, power source 130 is electrically decoupled from electronic load 115 and is electrically coupled to embedded signal generator 120 instead. Under this condition, object 110 is in an “off” state where primary functions of object 110 cannot be carried out. For example, when object 110 is a cellular phone and power switch 125 is set to an “off” position, the cellular phone cannot be used for receiving and sending calls. However, in this condition, power from power source 130 has been provided to embedded signal generator 120. Consequently, the RF receiver contained in embedded signal generator 120 is energized and is in condition to receive an RF signal transmitted by activator unit 105.

Furthermore, in one exemplary embodiment, when power switch 125 is in the “off” position, power source 130 provides power solely to embedded signal generator 120 and does not provide power to any other component in object 110.

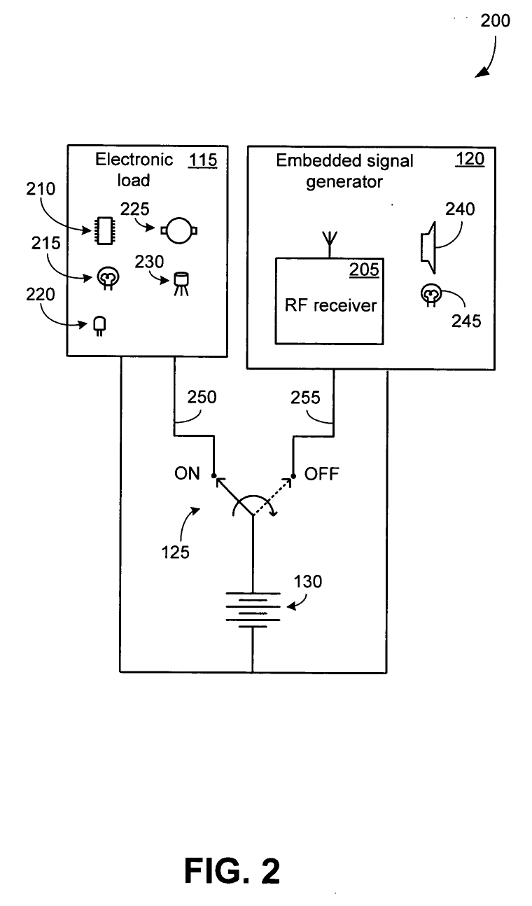

FIG. 2 shows a first exemplary embodiment of object locator circuitry 200 contained in an object, for example, a cellular telephone. Object locator circuitry 200 includes a power source 130, which is, in this example, a battery bank. Power switch 125 is a two-position switch. In this example, power switch is a toggle switch mounted on the front panel of object 200. When an operator of object 200 manually sets power switch 125 to the “on” position, power source 130 is coupled via link 250 to electronic load 115. When the operator sets power switch 125 to the “off” position, as indicated by the dashed arrow, power source 130 is coupled via link 255 to embedded signal generator 120.

Some elements of embedded signal generator are shown in FIG. 2. RF receiver 205 is configured to receive an RF signal from the activator unit (not shown). In a first embodiment, upon receiving the RF signal, embedded signal generator 120 generates an audible signal that is broadcast through loudspeaker 240. This audible signal is used to locate the object in which object locator circuitry 200 is housed. In a second embodiment, upon receiving the RF signal, embedded signal generator 120 generates a visual signal, such as a flashing strobe light, that is produced by lamp 245. This visual signal is used to locate the object in which object locator circuitry 200 is housed.

Electronic load 115 shows some exemplary elements. Integrated circuit (IC) 210, light-emitting diode (LED) 220, and transistor 230 may be mounted on a PCB located inside the object. Bulb 215 may be part of a front panel display, such as a status indicator or a panel illuminating element. Motor 225 may be a part of an electromechanical system, such as a lens-focusing system that is operated using power from power source 130.

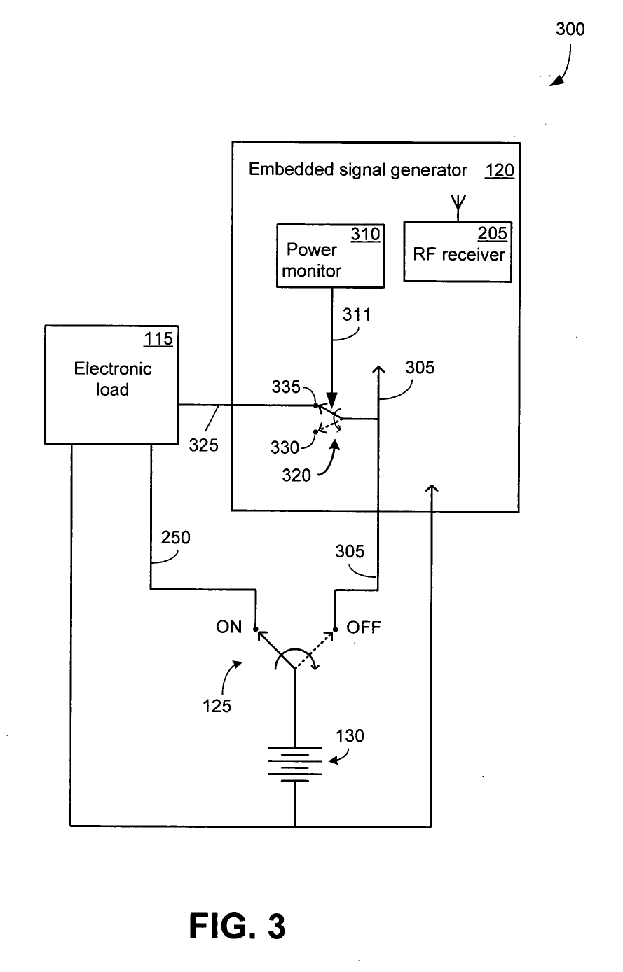

FIG. 3 shows a second exemplary embodiment of an object locator circuitry 300 contained in an object such as a cordless telephone handset. In this exemplary embodiment, embedded signal generator 120 includes a power monitor 310. Power monitor 310 monitors one or more parameters such as a voltage level and/or a current draw, on power provided by power source 130 to electronic load 115. The voltage level, for example, is monitored using link 305, which provides power to various components of embedded signal generator 120. Current drawn by electronic load 115 is monitored using link 325. Switch 320 is a two-position switch, such as an electromechanical relay or a solid-state switch, which is operated using a control signal generated by power monitor 310. This control signal is provided to switch 320 via link 311.

When power switch 125 is set to the “on” position, power from power source 130 is electrically coupled to electronic load 115 and electrically decoupled from embedded signal generator 120. This condition corresponds to a condition where the on-off switch of the cordless telephone handset is set to the “on” to make a phone call.

Turning to a condition where the on-off switch of the cordless telephone handset is set to the “off” position, i.e. where power switch 125 of FIG. 3 is set to the “off” position, power from power source 130 is electrically coupled to embedded signal generator 120 via link 305. Power to electronic load 115 via link 250 is decoupled because power switch 125 is no longer in the “on” position. However, when power switch 125 is in the “off” position, switch 320 is set to make contact with contact position 335 and power is provided to a portion of electronic load 115 via link 325.

Power monitor 310 is configured to detect a drop in power level below a predetermined threshold. In one embodiment, this is carried out by configuring power monitor 310 to measure current carried through link 325. The drop in power level below the predetermined threshold is indicated by the current level exceeding a pre-determined current amplitude.

In a second embodiment, power monitor 310 is configured to measure a voltage level present on link 305. The drop in power level below the predetermined threshold is indicated by the voltage level falling below a pre-determined voltage amplitude.

As one example, this pre-determined threshold corresponds to a voltage below which the display of the cordless telephone handset becomes inoperative. When this happens in a conventional system, the cordless telephone handset, which may include a handset locator circuit, becomes completely inoperative.

On the other hand, in accordance with this invention, upon detection of this threshold power level, power monitor 310 generates a control signal to operate switch 320 to move the switch wiper from contact position 335 to contact position 330. When in contact position 330, electrical power from link 305 is decoupled from link 325. However, embedded signal generator 120 remains operational via link 305, and is operative to provide location information upon receiving an RF signal from the activator unit (not shown).

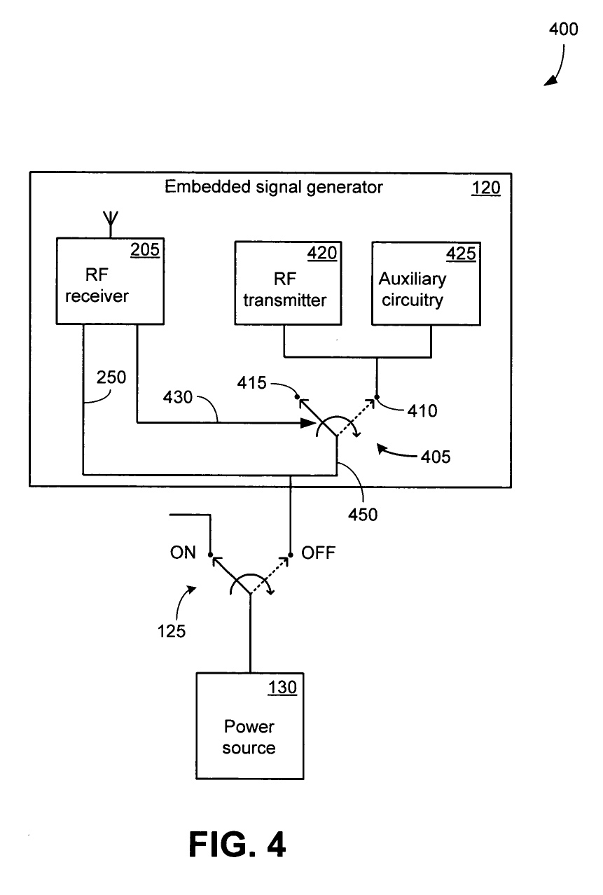

FIG. 4 shows a third exemplary embodiment of an object locator circuitry 400 contained in an object such as a personal digital assistant (PDA). Embedded signal generator 120 includes an RF receiver 205, an RF transmitter 420, and auxijiary circuitry 425. Auxiliary circuitry 425 includes circuits of embedded signal generator 120 that are not shown. For example, auxiliary circuitry 425 includes a locator signal generating circuit incorporating driver circuits used for driving a signal into a loudspeaker and/or a light bulb.

Switch 405 is a two-position switch such as an electromechanical relay or a solid-state switch, which is operated using a control signal generated by RF receiver 205. This control signal is provided to switch 405 via link 430.

When power switch 125 is set to the “off” position, power is provided to RF receiver 205 via link 450. However, switch 405 is set to a default condition where the switch wiper is positioned to couple link 450 to contact position 415. Consequently, power is decoupled from RF transmitter 420 and auxiliary circuitry 425, leading to minimized power consumption in embedded signal generator 120. In an alternative embodiment, where a transmitter is optional, RF transmitter 420 is omitted from embedded signal generator 120, leading to a further reduction in power consumption

Upon receiving a signal from an activator unit (not shown), RF receiver 205 provides a control signal to switch 405. The control signal causes the switch wiper of switch 405 to be moved to contact position 410, thereby providing power to auxiliary circuitry 425 and RF transmitter 420. Auxiliary circuitry 425 is operated to generate a locator signal.

In one embodiment, switch 405 remains in this position thereafter. In an alternative embodiment, after a suitable delay, RF receiver 205 provides a second control signal via link 430 to operate switch 405 to revert to coupling link 450 to contact position 415.

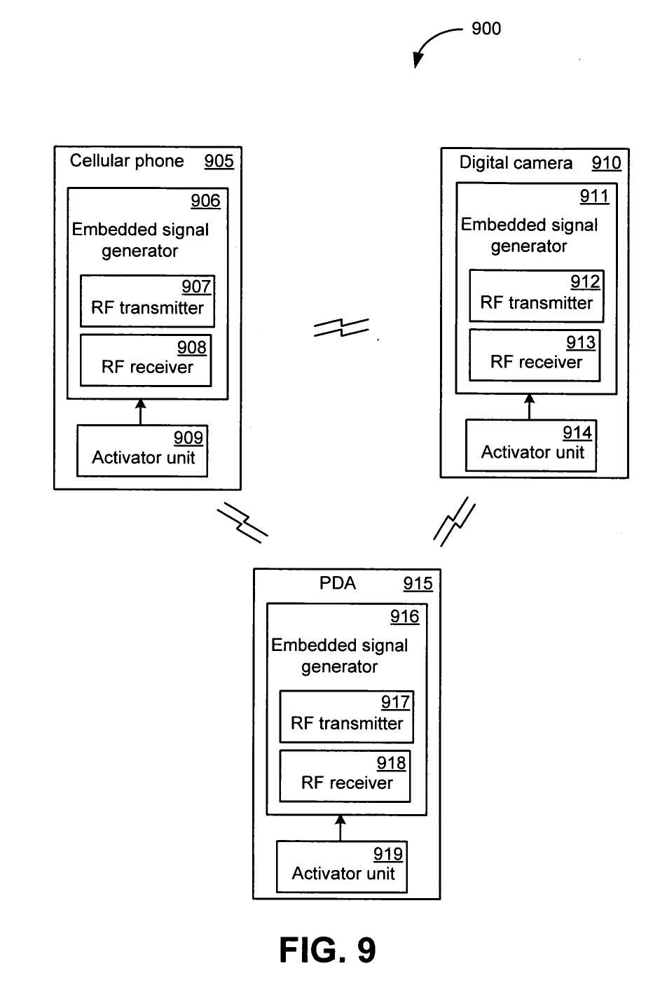

In one of several functional modes, RF transmitter 420 is used to transmit an RF signal for locating a second object other than the object in which object locator circuitry 400 is incorporated. This aspect will be described below in further detail using FIG. 9.

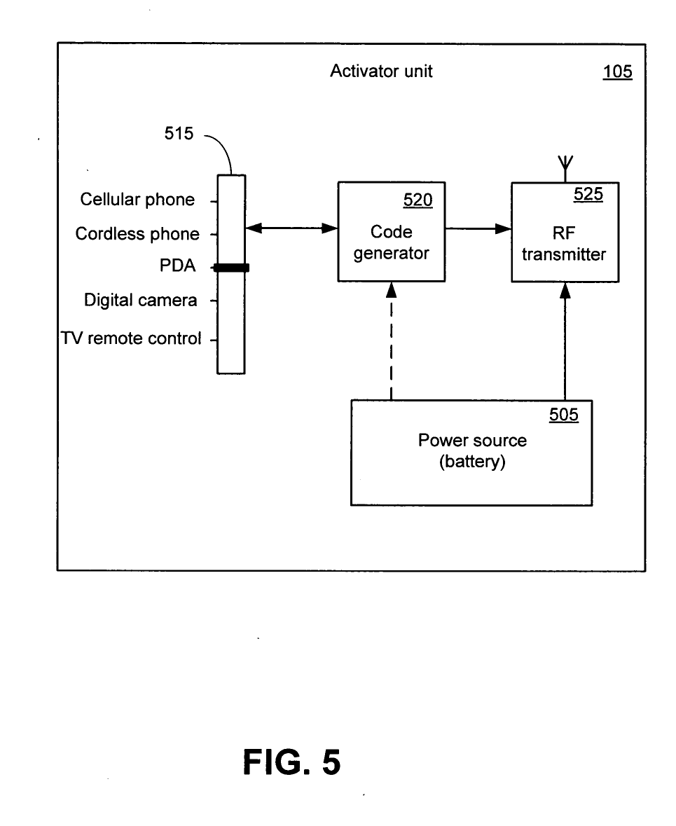

FIG. 5 shows a first exemplary embodiment of object locator circuitry contained in activator unit 105. Object selector 515 is a selector switch used to select one of several alternative devices for which location information is desired. In this example, object selector 515 is shown set to select a PDA. The PDA (not shown) has been misplaced and location information is therefore desired for locating the PDA. Object selector 515 may be implemented using several alternative devices, such as a slide switch, a rotary. selector switch, and/or an array of individual buttons.

Code generator 520 is used to generate a coded RF signal that is provided to RF transmitter 525 for wireless transmission. The coded RF signal is unique for each of the devices that are selectable using object selector 515. Consequently, a first coded RF signal is transmitted when the PDA is selected using object selector 515, and a different coded signal is transmitted when the cellular phone is selected, for example.

In this exemplary embodiment, activator unit 105 is a portable device, such as a hand-held unit, and power source 505 is a battery. In an alternative embodiment, activator unit 105 is a non-portable unit, such as a desktop unit powered by an AC power source.

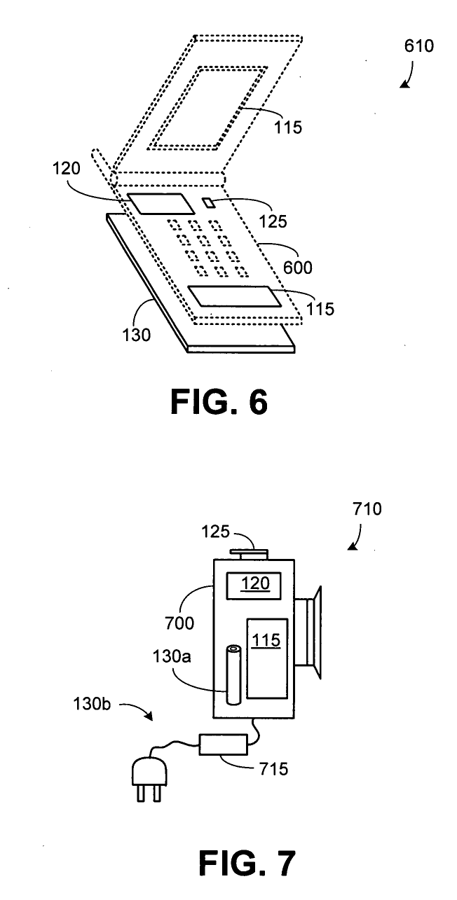

FIG. 6 shows a first exemplary object, a cellular telephone 610, that houses object locator circuitry in accordance with the invention. Power source 130 is a battery pack that is typically coupled on to enclosure 600 of cellular telephone 610. The object locator circuitry is housed inside enclosure 600. Power switch 125 is an on-off button switch that is a part of a keypad of cellular telephone 610. Embedded signal generator 120 operates as described above with reference to other figures. Electronic load 115 includes telephone circuitry that is operated from power source 130. Such circuitry includes call-processing circuits as well as the display unit.

FIG. 7 shows a second exemplary object, a digital camera 710, that houses object locator circuitry in accordance with the invention. In this exemplary object, two alternative power sources are disclosed. The first power source is a battery 130a while the second power source is an AC power supply 130b. AC power supply 130b includes an AC-to-DC converter 715, which converts the AC power to a DC voltage that is typically coupled to digital camera 710 when battery 130a is discharged. The object locator circuitry is housed inside camera enclosure 700. Power switch 125 is an on-off rotary switch that is located on an upper surface of digital camera 710.

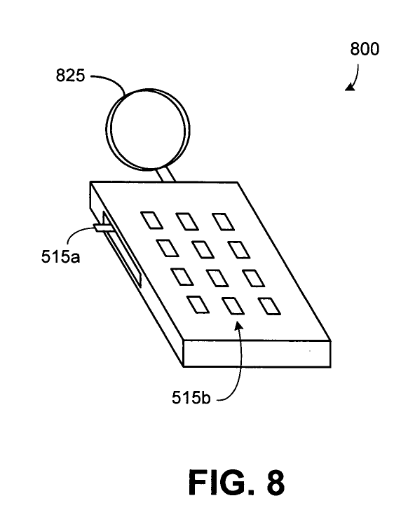

FIG. 8 shows a first exemplary embodiment of an activator unit 800 that houses object locator circuitry in accordance with the invention. Slide switch 515a is used to select a misplaced device for obtaining location information. Alternatively, an array of buttons 515b is used to carry out selection of an object. In addition to operating as an object selector, the array of buttons 515b may be used for other purposes as well. Activator unit 800 is a hand-held unit that is attached to a key ring 825 for convenience.

FIG. 9 shows an exemplary object locator network 900 in accordance with the invention. While object locator network 900 may be formed with a minimum of two objects; in this exemplary network, three objects - a cellular phone 905, a digital camera 910, and a PDA 915, are used. Each of the three objects includes an embedded signal generator and an activator unit. The three objects are communicatively coupled to each other, and any one of the three objects is used to obtain location information of either of the other two objects. For example, PDA 915 may be used to locate cellular phone 905 that has been misplaced.

This is carried out by using activator unit 919, which contains object locator circuitry as described above. Using this circuitry, the object selector (not shown) is used to select a cellular phone. Activator unit 919 communicates with RF transmitter 917, which transmits an RF signal. The RF signal is received by RF receiver 908 of cellular phone 905. Upon receiving this RF signal, embedded signal generator 906 generates an object locator signal such as an audible beep or a flashing display. The object locator signal is used to locate the misplaced cellular phone 905.

Reciprocally, cellular phone 905 may be used to locate PDA 915. This is carried out by selecting the PDA on the object selector of activator unit 909. Activator unit 909 communicates with RF transmitter 907, which transmits an RF signal. The RF signal is received by RF receiver 918 of PDA 915. Upon receiving this RF signal, embedded signal generator 916 generates an object locator signal such as an audible beep or a flashing display. The object locator signal is used to locate the misplaced PDA 915.

In a first embodiment, embedded signal generator of any individual object of object locator network 900 is coupled to a power source contained in the individual object only when the power switch of the individual object is set to an “off” position. In a second embodiment, the embedded signal generator of any individual object of object locator network 900 is powered only when the power switch of the individual object is set to an “on” position. In a third embodiment, the power switch of any individual object of object locator network 900 is excluded from the object locator system inside the individual object, and the embedded signal generator remains operational irrespective of the setting of the power switch.

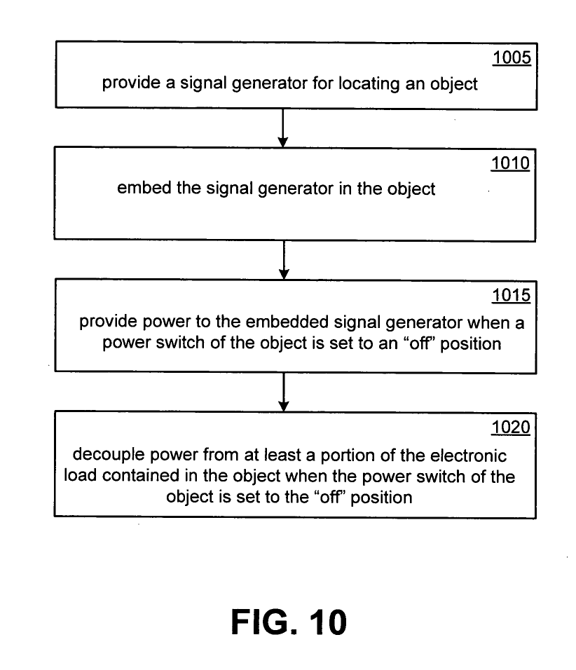

FIG. 10 is a flowchart of an exemplary method of locating an object. In block 1005, a signal generator is provided. The signal generator is operative to generate an object locator signal that is used to locate a misplaced object. In block 1010, the signal generator is embedded inside the object. Typically, the signal generator is embedded into the object during manufacture of the object. Embedding the signal generator in the object eliminates external attachment to the object thereby avoiding certain handicaps associated with such an external attachment.

In block 1015, power is provided to the embedded signal generator when a power switch of the object is set to an “off” position. This step enables the embedded signal generator to be operative to generate an object locator signal that provides location information of the object when the object is misplaced.

In block 1020, power is electrically decoupled from at least a portion of the electronic load contained in the object when the power switch of the object is set to the “off” position. In an alternative embodiment, power is electrically decoupled from the entire electronic load contained in the object when the power switch of the object is set to the “off” position. Under this condition, only the embedded signal generator is provided power.

The above-described embodiments are merely set forth for a clear understanding of the principles of the disclosure. Many variations and modifications may be made without departing substantially from the disclosure. All such modifications and variations are included herein within the scope of this disclosure.

I claim:

1. An object locator system comprising:
an object, the object comprising:
a power source;
an electronic load;
an embedded signal generator operable to generate a signal that provides location information of the object;
a power switch settable to one of at least two positions, wherein when set to a first position the power source is coupled to the electronic load, and wherein when set to a second position the power source is coupled to the embedded signal generator; and
a power monitor operable to monitor the power source when the power switch is set to the second position and further operable to generate a control signal to decouple the power source from the electronic load when power provided by the power source drops below a first threshold; and
an activator unit operable to transmit a radio-frequency (RF) signal to the embedded signal generator.

2. The object locator system of claim 1, wherein the object is a hand-held device.

3. The object locator system of claim 2, wherein the hand-held device is one of a) a cellular phone, b) a camera, c) a personal digital assistant (PDA), d) a laptop computer, e) a music player, f) a video camera, and g) a gaming system.

4. The object locator system of claim 1, further comprising a second switch that is operated using the generated control signal, the second switch operable to decouple the power source from the electronic load.

5. The object locator system of claim 1, wherein the power switch is a mechanical switch in which the first position is an “on” position and the second position is an “off”position.

6. The object locator system of claim 1, wherein the embedded signal generator generates at least one of an audible signal and a visual signal.

7. The object locator system of claim 1, wherein the embedded signal generator comprises an RF receiver configured to receive the RF signal transmitted by the activator unit.

8. The object locator system of claim 7, further comprising:
an RF transmitter; and
a second switch settable to one of at least two positions, wherein when set to a first position the power source is coupled to the RF transmitter, and wherein when set to a second position the power source is decoupled from the RF transmitter.

9. The object locator system of claim 8, wherein the power switch is a mechanical switch and the second switch is one of an electromechanical switch and a solid state switch that is controlled by the RF receiver.

10. The object locator system of claim 1, wherein the first threshold comprises one of a) a voltage amplitude and b) a current amplitude.

11. An object locator system comprising:
an object, the object comprising:
a power source;
an electronic load;
an embedded signal generator operable to generate a signal that provides location information of the object; and
a power switch settable to one of at least two positions, wherein when set to a first position the power source is coupled to the electronic load; wherein when set to a second position the power source is coupled to the embedded signal generator; and further wherein when set to the second position the loading on the power source consists of the embedded signal generator; and
an activator unit operable to transmit a radio-frequency (RF) signal to the embedded signal generator.

12. The object locator system of claim 11, wherein the electronic load is operative to perform a function of the object, and further wherein the electronic load comprises one of a) an electronic circuit, b) an electrical circuit, and c) an electro-mechanical system.

13. The object locator system of claim 11, wherein the object is a hand-held device.

14. The object locator system of claim 13, wherein the hand-held device is one of a) a cellular phone, b) a camera, c) a personal digital assistant (PDA), d) a laptop computer, e) a music player, f) a video camera, and g) a gaming system.

15. The object locator system of claim 1 1, wherein the power source comprises one of a) a battery, b) an AC-to-DC power supply, c) an AC-to-AC power supply, and d) a DC-to-DC power supply.

16. An object locator network, the network comprising:
a first object comprising a first embedded signal generator operable to generate a first object locator signal that provides location information of the first object;
a second object comprising a second embedded signal generator operable to generate a second object locator signal that provides location information of the second object; and
wherein the first embedded signal generator is communicatively coupled to the second embedded signal generator.

17. The network of claim 16, wherein the first embedded signal generator comprises:
a first RF receiver operable to receive a first RF signal that triggers the first embedded signal generator to generate the first object locator signal; and
a first RF transmitter configured to transmit a second RF signal that triggers the second embedded signal generator to generate the second object locator signal.

18. The network of claim 17, wherein the second embedded signal generator comprises:
a second RF receiver operable to receive the second RF signal that triggers the second embedded signal generator to generate the second object locator signal; and
a second RF transmitter configured to transmit the first RF signal that triggers the first embedded signal generator to generate the first object locator signal.

19. The network of claim 17, further comprising:
a third object comprising a third embedded signal generator operable to generate a third object locator signal that provides location information of the third object; and wherein the third embedded signal generator is communicatively coupled to the first embedded signal generator and the second embedded signal generator.

20. The network of claim 19, wherein the third embedded signal generator comprises:
a third RF receiver operable to receive at least one of a) the first RF signal and b) the second RF signal, which triggers the second embedded signal generator to generate the third object locator signal; and
a third RF transmitter configured to transmit at least one of a) the first RF signal and b) the second RF signal.
